(19) United States
(12) Patent Application Publication
(10) Pub. No.: US 2024/0298200 A1
(43) Pub. Date: Sep. 5, 2024

(54) METHOD FOR ESTIMATING SIGNAL TO INTERFERENCE PLUS NOISE RATIO (SINR) DISTRIBUTION FROM STATISTICAL CHANNEL QUALITY INDICATOR (CQI) REPORT

(71) Applicant: Telefonaktiebolaget LM Ericsson (publ), Stockholm (SE)

(72) Inventors: Jonas FRÖBERG OLSSON, Ljungsbro (SE); Alexey SHAPIN, Luleå (SE)

(21) Appl. No.: 18/551,744

(22) PCT Filed: Mar. 29, 2022
(86) PCT No.: PCT/SE2022/050302

§ 371 Date: Sep. 21, 2023

Related U.S. Application Data
(60) Provisional application No. 63/169,615, filed on Apr. 1, 2021.

(51) Int. Cl. H04W 24/10; H04B 17/26; H04B 17/336; H04L 5/00

(52) U.S. Cl. CPC H04W 24/10; H04B 17/336; H04L 5/0057; H04B 17/26

(57) ABSTRACT

A method, system and apparatus are disclosed. According to one or more embodiments, a network node configured to communicate with a wireless device (WD) is provided. The network node is configured to, and/or includes a radio interface and/or includes processing circuitry configured to receive a plurality of statistical measures in a statistical channel state information, CSI, reporting unit, determine a plurality of distribution parameters for signal to interference plus noise ratio, SINR, based at least on the plurality of statistical measures, and perform at least one action based at least on the plurality of distribution parameters.

### TECHNICAL FIELD

The present disclosure relates to wireless communications, and in particular, to statistical channel state information (CSI) reports for evaluating a wireless communication channel.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

### Channel State Information (CSI) Reporting in New Radio

Due to the varying nature of a wireless communication channel, data transmission between a network node (e.g., eNB) and wireless device (e.g., WD), the modulation scheme and code rate are adapted to suit different channel conditions. In NR, downlink transmission methods such as multi-layer transmission, transmission point selection, beam selection, etc., are very flexible. Therefore, in NR, the CSI may include one or more of:
CQI: Channel Quality Indicator;
PMI: Pre-coding Matrix Indicator;
CRI: CSI-RS Resource Indicator;
LI: Layer Indicator;
SSBRI: SS/PBCH Block Resource Indicator; and
L1-RSRP.

In NR, the reported CQI value can be with respect to one of three tables, namely Table 1, Table 2 and Table 3, that may correspond to tables in 3GPP wireless communication standards such as in 3GPP Technical Specification (TS) 38.214, v15.7.0. If Table 1 or Table 2 is configured, the wireless device reports a channel quality indicator (CQI) value such that a physical downlink shared channel (PDSCH) with modulation, target code rate and transport block size corresponding to the CQI value assigned on a CSI reference resource could be received with a BLEP (Block-Error Probability) not exceeding 10%. For Table 1, the highest modulation is 64 quadrature amplitude modulation (QAM) while for Table 2 the highest modulation is 256 QAM. For Table 3 the highest modulation is 64 QAM but the BLEP does not exceed 10⁻⁵. Section 5.2.2.1 in 3GPP TS 38.214, v15.7.0 provides the following:
The CQI indices and their interpretations are given in Table 5.2.2.1-2 or Table 5.2.2.1-4 of 3GPP TS 38.214, v15.7.0, for reporting CQI based on QPSK, 16QAM and 64QAM. The CQI indices and their interpretations are given in Table 5.2.2.1-3 of 3GPP TS 38.214, v15.7.0, for reporting CQI based on QPSK, 16QAM, 64QAM and 256QAM.

Based on an unrestricted observation interval in time, unless specified otherwise in this Subclause, [and an unrestricted observation interval in frequency-TBD], the wireless device derives for each CQI value reported in uplink slot n the highest CQI index, which satisfies the following condition:
A single PDSCH transport block with a combination of modulation scheme, target code rate and transport block size corresponding to the CQI index, and occupying a group of downlink physical resource blocks termed the CSI reference resource, could be received with a transport block error probability not exceeding:
   0.1, if the higher layer parameter cqi-Table in CSI-ReportConfig configures ‘table1’ (corresponding to, for example, Table 5.2.2.1-2), or ‘table2’ (corresponding to, for example, Table 5.2.2.1-3 of 3GPP TS 38.214, v15.7.0); or
   0.00001, if the higher layer parameter cqi-Table in CSI-ReportConfig configures ‘table3’ (corresponding to, for example, Table 5.2.2.1-4 of 3GPP TS 38.214, v15.7.0).

The CSI reporting can be time-restricted for either or both of channel and interference measurement by parameters:
timeRestrictionForChannelMeasurements; and
timeRestrictionForInterferenceMeasurements.

If a time restriction for measurement is configured, the CSI reported is based on only the most recent measurement (as described in 3GPPTS 38.214, v15.7.0 Section 5.2.2.1):
If a wireless device is configured with the higher layer parameter time RestrictionForChannelMeasurements in CSI-ReportConfig, the wireless device derives the channel measurements for computing CSI reported in uplink slot n based on only the most recent occasion of NZP CSI-RS and no later than the CSI reference resource associated with the CSI resource setting (as described in 3GPP TS 38.211).
If a wireless device is configured with the higher layer parameter time RestrictionForInterferenceMeasurements in CSI-ReportConfig, the wireless device derives the interference measurements for computing the CSI value reported in the uplink slot n based on the most recent occasion of CSI-IM and/or NZP CSI-RS for interference measurement, and no later than the CSI reference resource associated with the CSI resource setting (as described in 3GPP TS 38.211).

This means that if a time-restriction is enabled, then the reported CSI is a momentary evaluation of the channel and interference at the time of channel measurement and at the time of interference measurement. The time for measurement of the channel may not be the same as the time of interference measurement. If, however, the time-restriction is not configured, the wireless device can report CSI based on more than one measurement. How the wireless device obtains CSI based on several measurements depends on specific wireless device implementation.

NR also supports CSI reporting of layer 1 reference signal received power (L1-RSRP), where channel quality measures are determined without taking spatial properties nor interference into account.

CSI reporting configured via CSI-ReportConfig can have one, two or three resource settings where the resource settings can be one of three types: aperiodic, semi-persistent and periodic. A resource setting specifies one or more measurement resources. If one resource setting is configured, the parameter resourcesForChannelMeasurement is used for L1-RSRP channel measurement. If two resource settings are configured, resourcesForChannelMeasurement is used for channel measurement while the second resource setting is used for interference measurement. The second resource setting may be either specified via csi-IM-ResourceForInterference or nzp-CSI-RS-ResourcesForInterference. When a nzp-CSI-RS resource for interference measurement is configured, the wireless device performs channel estimation on the actual CSI-RS transmitted but interprets the signal as interference in CSI evaluation. Three resources settings can also be configured wherein resourcesForChannelMeasurement specifies resources for channel measurement and both the csi-IM-ResourceForInterference and nzp-CSI-RS-ResourcesForInterference specifies the resources for interference measurement.

Periodic CSI reports are sent on the physical uplink control channel (PUCCH) (uplink control information (UCI) on physical uplink shared channel (PUSCH) when there is PUSCH data) and can be linked to periodic or semi-static resource setting(s). Semi-persistent CSI reports can be sent on PUCCH or PUSCH (with or without PUSCH data) and can also be linked to periodic or semi-static resource setting(s). Only a-periodic CSI reports can be linked to all three types of resource settings (periodic, semi-static and a-periodic). For a-periodic CSI reports a CSI-AperiodicTriggerState is associated with one or more CSI-ReportConfig and a CSI trigger state is further associated with a codepoint of the “CSI request” field in DCI.

In NR 3GPP Release 16 (3GPP Rel-16), the CSI reference resource for a serving cell is defined as follows:
In the frequency domain, the CSI reference resource is defined by the group of downlink physical resource blocks corresponding to the band to which the derived CSI relates; and
In the time domain, the CSI reference resource for a CSI reporting in uplink slot n′ is defined by a single downlink slot n-nesi ref.

If configured to report CQI index, in the CSI reference resource, the wireless device may assume one or more of the following for the purpose of deriving the CQI index, and if also configured, for deriving PMI and rank indicator (RI):
The first 2 OFDM symbols are occupied by control signaling;
The number of physical downlink shared channel (PDSCH) and demodulation reference signal (DM-RS) symbols is equal to 12;
The same bandwidth part subcarrier spacing configured as for the PDSCH reception;
The bandwidth as configured for the corresponding CQI report;
The reference resource uses the cyclic prefix (CP) length and subcarrier spacing configured for PDSCH reception;
No resource elements used by primary or secondary synchronization signals or PBCH;
5-Redundancy Version 0;
The ratio of PDSCH EPRE to CSI-RS EPRE may be, for example, as given in Subclause 4.1 of 3GPP wireless communication standards such as 3GPP Technical Release 16 (3GPP Rel-16);
Assume no resource elements (REs) allocated for NZP CSI-RS and ZP CSI-RS;
Assume the same number of front loaded DM-RS symbols as the maximum front-loaded symbols configured by the higher layer parameter maxLength in DMRS-DownlinkConfig;
Assume the same number of additional DM-RS symbols as the additional symbols configured by the higher layer parameter dmrs-AdditionalPosition;
Assume the PDSCH symbols are not containing DM-RS;
Assume PRB bundling size of 2 PRBs; and/or
The PDSCH transmission scheme where the wireless device may assume that PDSCH transmission would be performed with up to 8 transmission layers as defined in Subclause 7.3.1.4 of 3GPP TS 38.211. For CQI calculation, the wireless device assumes that PDSCH signals on antenna ports in the set [1000, . . . , 1000+v−1] for v layers would result in signals equivalent to corresponding symbols transmitted on antenna ports [3000, . . . , 3000+P−1], as given by

$$[ \begin{matrix}{y}^{( 3000 )} ( i ) \\ … \\ {y}^{( 3000 + P - 1 )} ( i )\end{matrix} ] = W ( i ) [ \begin{matrix}{x}^{( 0 )} ( i ) \\ … \\ {x}^{( v - 1 )} ( i )\end{matrix} ]$$

where x(i)=[x⁽⁰⁾(i) . . . x^{(v-1)}(i)]^{T} (is a vector of PDSCH symbols from the layer mapping defined in Subclause 7.3.1.4 of 3GPP wireless communication standards such as 3GPP TS 38.211, P∈[1,2,4,8,12,16,24,32] is the number of CSI-RS ports.

If only one CSI-RS port is configured, W(i) is 1. If the higher layer parameter reportQuantity in CSI-ReportConfig for which the CQI is reported is set to either ‘cri-RI-PMI-CQI’or ‘cri-RI-LI-PMI-CQI’, W(i) is the precoding matrix corresponding to the reported PMI applicable to x(i). If the higher layer parameter reportQuantity in CSI-ReportConfig for which the CQI is reported is set to ‘cri-RI-CQI’, W(i) is the precoding matrix corresponding to the procedure described in Subclause 5.2.1.4.2 of 3GPP TS 38.214, v15.7.0. If the higher layer parameter reportQuantity in CSI-ReportConfig for which the CQI is reported is set to ‘cri-RI-i1-CQI’, W(i) is the precoding matrix corresponding to the reported i1 according to the procedure described in Subclause 5.2.1.4 of 3GPP TS 38.214, v15.7.0. The corresponding PDSCH signals transmitted on antenna ports [3000, . . . , 3000+P−1] would have a ratio of EPRE to CSI-RS EPRE equal to the ratio given in Subclause 5.2.2.3.1 of 3GPP wireless communication standards such as 3GPP TS 38.214, v15.7.0.

A combination of modulation scheme and transport block size corresponds to a CQI index if:
the combination could be signaled for transmission on the PDSCH in the CSI reference resource according to the Transport Block Size determination described in Subclause 5.1.3.2 of 3GPP wireless communication standards such as 3GPP TS 38.214, v15.7.0;
the modulation scheme is indicated by the CQI index; and
the combination of transport block size and modulation scheme when applied to the reference resource results in the effective channel code rate which is the closest possible to the code rate indicated by the CQI index. If more than one combination of transport block size and modulation scheme results in an effective channel code rate equally close to the code rate indicated by the CQI index, only the combination with the smallest of such transport block sizes is relevant.
   3GPP TS 38.214 V15.6.0, Table 5.2.2.1-2: 4-bit CQI Table 1

| CQI | | code rate × | |
|---|---|---|---|
| index | modulation | 1024 | efficiency |

| | |
|---|---|
| 0 | out of range |

| | | | |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

3GPP TS 38.214 V15.6.0, Table 5.2.2.1-3: 4-bit CQI Table 2

| CQI | | code rate × | |
|---|---|---|---|
| index | modulation | 1024 | efficiency |

| | |
|---|---|
| 0 | out of range |

| | | | |
|---|---|---|---|
| 1 | QPSK | 78 | 0.1523 |
| 2 | QPSK | 193 | 0.3770 |
| 3 | QPSK | 449 | 0.8770 |
| 4 | 16QAM | 378 | 1.4766 |
| 5 | 16QAM | 490 | 1.9141 |
| 6 | 16QAM | 616 | 2.4063 |
| 7 | 64QAM | 466 | 2.7305 |
| 8 | 64QAM | 567 | 3.3223 |
| 9 | 64QAM | 666 | 3.9023 |
| 10 | 64QAM | 772 | 4.5234 |
| 11 | 64QAM | 873 | 5.1152 |
| 12 | 256QAM | 711 | 5.5547 |
| 13 | 256QAM | 797 | 6.2266 |
| 14 | 256QAM | 885 | 6.9141 |
| 15 | 256QAM | 948 | 7.4063 |

3GPP TS 38.214 V15.6.0, Table 5.2.2.1-4: 4-bit CQI Table 3

| CQI | | code rate × | |
|---|---|---|---|
| index | modulation | 1024 | efficiency |

| | |
|---|---|
| 0 | out of range |

| | | | |
|---|---|---|---|
| 1 | QPSK | 30 | 0.0586 |
| 2 | QPSK | 50 | 0.0977 |
| 3 | QPSK | 78 | 0.1523 |
| 4 | QPSK | 120 | 0.2344 |
| 5 | QPSK | 193 | 0.3770 |
| 6 | QPSK | 308 | 0.6016 |
| 7 | QPSK | 449 | 0.8770 |
| 8 | QPSK | 602 | 1.1758 |
| 9 | 16QAM | 378 | 1.4766 |
| 10 | 16QAM | 490 | 1.9141 |
| 11 | 16QAM | 616 | 2.4063 |
| 12 | 64QAM | 466 | 2.7305 |
| 13 | 64QAM | 567 | 3.3223 |
| 14 | 64QAM | 666 | 3.9023 |
| 15 | 64QAM | 772 | 4.5234 |

### Scheduling and Link Adaptation

The scheduler and link adapter in the network node has the task of selecting a transport format including allocation, number of layers, modulation and coding scheme for a PDSCH transmission based on reported CSI from the wireless device. Recall that CSI is reported with respect to a CSI reference resource, which means that CSI reflects the quality a PDSCH transmitted on the CSI reference resource. Thus, if CSI is a wideband report, the indicated quality is for a PDSCH with wideband allocation. Hence, if the scheduler of the network node prefers to schedule the wireless device with an allocation that is different from the CSI reference resource, the scheduler and link adaption may need to estimate what the quality would be for the different allocation.

One way to perform such an estimation could be to assume that quality is the same irrespectively of the allocation. This is, however, not true but could be an acceptable assumption in many cases. It is well-known that an error-correcting code such as low density parity check (LDPC) code has the property that BLEP is lower for large codeword than for a smaller codeword. This means that to achieve the same BLEP for two PDSCHs with the same modulation and coding scheme but where first PDSCH has a smaller allocation size, the required SINR is higher for first PDSCH. Because of this, link adaption is often performed using a coding model of the error correcting code. The coding model can estimate what BLEP could be expected for a PDSCH with a certain modulation and coding scheme and allocation size given a certain SINR. The coding model can also convert a CQI value to a SINR value. This can be achieved by determining the required SINR values for each of the CQI values. For example, the 256 QAM CQI table could be appended with a required SINR column, as shown in the example of Table 4.

TABLE 4
Required WB SINR for CQI values in 256QAM table

| CQI | | code rate × | | Required WB SINR |
|---|---|---|---|---|
| index | modulation | 1024 | efficiency | [dB] |
| 0 | out of range | | | — |
| 1 | QPSK | 78 | 0.1523 | −7.7 |
| 2 | QPSK | 193 | 0.3770 | −4.5 |
| 3 | QPSK | 449 | 0.8770 | 0.3 |
| 4 | 16QAM | 378 | 1.4766 | 4.2 |
| 5 | 16QAM | 490 | 1.9141 | 6.0 |
| 6 | 16QAM | 616 | 2.4063 | 8.0 |
| 7 | 64QAM | 466 | 2.7305 | 10.3 |
| 8 | 64QAM | 567 | 3.3223 | 12.0 |
| 9 | 64QAM | 666 | 3.9023 | 13.9 |
| 10 | 64QAM | 772 | 4.5234 | 15.6 |
| 11 | 64QAM | 873 | 5.1152 | 17.4 |
| 12 | 256QAM | 711 | 5.5547 | 19.6 |
| 13 | 256QAM | 797 | 6.2266 | 21.0 |
| 14 | 256QAM | 885 | 6.9141 | 23.0 |
| 15 | 256QAM | 948 | 7.4063 | 24.4 |

As illustrated in Table 4, CQI indices approximately samples the SINR range in 2 dB steps except for the low CQI values. From Table 4 it is deduced that if CQI=5, then the “reported” SINR could be estimated to be in the range [6.0, 8.0]. For ultra-reliable and low latency communications (URLLC) having a high reliability requirement, the link adaption may be conservative and assume an estimated “reported” SINR of 6.0 dB, for example. For evolved mobile broadband (eMBB) communications, the link adaption may assume a middle value, such as 7.0 dB.

For URLLC, link adaptation is a challenging task due to the high reliability requirements, especially if the transport format also should be spectrally efficient. Since the PDSCH transmission occurs later than when the CSI was measured, the scheduler and link adapter have to predict the SINR (Signal-to-Noise-and-Interference Ratio) at transmission based on a “reported” SINR that can be determined from reported CSI. One such prediction typically used is that predicted SINR equals the “reported” SINR. This may work well in cases when transmissions can be “saved” by hybrid automatic repeat request (HARQ) re-transmissions. For URLLC, the latency requirement puts a limit on the number of re-transmissions that can be performed, and the reliability requirement puts a limit on the probability that the data could not be correctly decoded within the limit on number of (re-) transmissions. For URLLC, the assumption that the “reported” SINR SINRᵣₑₚ corresponds to a prediction SINR_{pred} of the SINR at the PDSCH transmission can lead to that the requirements cannot be fulfilled.

The uncertainty in the SINR given the “reported” SINRᵣₑₚ, should be accounted for in link adaptation in order to meet latency and reliability requirements. One way the network node can currently estimate this uncertainty is based on received CSI reports. The uncertainty may be larger for assignments consisting of few resource blocks (RBs) than for assignments consisting of many RBs.

One way to mitigate the un-certainty is to apply a back-off to the “reported” SINRᵣₑₚ. The back-off could be a fixed value or an outer-loop adjusted value triggered by a HARQ-acknowledgement (ACK) reported by the wireless device. For URLLC it may be especially difficult to select the back-off since reliability requires that essentially all reported HARQ-ACKs must be ACK, which in turn means that the benefit with an outer-loop becomes limited. Furthermore, a suitable back-off often depends on number of layers and the allocation size of the PDSCH, which add to the complexity of its use in URLLC.

Enhancements have been considered where the wireless device reports statistical CSI, e.g., mean and std (standard-deviation) over several time-instances, where the statistical CSI is determined by the wireless device. Precisely how the wireless device determines mean and standard deviation of a CSI unit is expected to be wireless device-specific (and is still undefined) and the reporting of indicators for mean and standard deviation transmitted from the wireless device to the network node is still undefined in 3GPP specification.

Since there was no CSI statistics reporting in NR, the introduction of such a metric requires new methods for the network node to use the CSI statistics reporting in link adaptation. In particular, there is no known method for estimating a distribution of SINR from reported CSI statistics not in the SINR domain.

### SUMMARY

Some embodiments advantageously provide methods, systems, and apparatuses for using statistical CSI reports for evaluating a wireless communication channel.

As discussed above, it is not defined how a wireless device determines a mean and standard deviation of a CSI unit where such definition includes a reporting unit such as CQI, SINR and symbol information. For example, if the reporting unit is CQI, one method to determine mean and standard deviation CQI may be to determine mean and standard deviation of decimal CQI values determined from CSI measurements, i.e., when determining mean and standard deviation CQI the values are not quantized to integer values. A decimal CQI value (decCQI) according to a CQI table, e.g., Table 1 or Table 4, can be deduced from SINR or an efficiency value by interpolation, e.g., a SINR=7.0 dB could be determined as decCqi=5.5. Since the required SINR is a wireless device-specific property, other wireless devices may have a different column of required SINR or base CQI determination on efficiency instead of SINR. However, in terms of CQI and efficiency, the reported value may mean the same thing for all wireless devices. Hence, there may be inconsistency in actual SINR reported from several wireless devices even though the reported value means the same thing for all the wireless devices. Further, it is yet not defined how the network node analyzes the statistical information for performing a network node action.

One or more embodiments solve one or more problems with existing systems/discussions by at least providing a method in a network node for link adaptation to estimate/select distribution parameters for SINR based on reported mean and standard deviation (or variance, percentile) of statistical CSI units is provided.

In one or more embodiments, an estimate of distribution parameters for SINR is determined based on reported statistical CSI measures (mean, variance, percentile) in a statistical CSI reporting unit where at least one of the SINR distribution parameters is determined based on at least two of the reported statistical CQI measures. In one or more embodiments, a statistical CSI consists of mean and standard deviation CQI where at least one of the distribution parameters are determined based on both the mean CQI and the standard deviation CQI. In one such example, SINR is assumed to be normally distributed with a standard deviation determined based on both mean CQI and standard deviation CQI indicators.

In one or more embodiments, at least one of the SINR distribution parameters may be further determined based on one or more of:
Reliability requirement;
Latency requirement; and
HARQ-ACK.

One or more embodiments of the present disclosure advantageously provide for determining precise estimates of SINR distribution parameters that enables the link adapter and scheduler in a network node to maximize spectral efficiency while ensuring that latency and reliability requirements can be met.

According to one aspect, an exemplary process in a network node includes receiving an indicator of at least one channel state statistical value from the WD, a channel state statistical value being determined based at least in part on a plurality of channel state measurements. The process also includes estimating a signal-to-interference-plus-noise ratio, SINR distribution based at least in part on the at least one channel state statistical value. The process further includes performing at least one action based at least in part on the estimated SINR distribution.

According to this aspect, in some embodiments, the at least one channel state statistical value includes a mean and one of a standard deviation and a variance. In some embodiments, the at least one channel state statistical value includes a skewness. In some embodiments, the at least one channel state statistical value is based at least in part on at least one of a channel quality indicator, CQI, and an efficiency. In some embodiments, the estimated SINR distribution is obtained from at least one of a table and a mapping function that provides an SINR value for a given value of the received indicator. In some embodiments, the received indicator is mapped to a range of statistical values, and the method further includes selecting a value in the range of statistical values based at least in part on at least one of a latency requirement and a reliability requirement. In some embodiments, the process includes selecting a lowest value in the range of statistical values for ultra-reliable and low latency communications, URLLC. In some embodiments, estimating the SINR distribution includes adjusting an indicated channel state statistical value based on at least one of received hybrid automatic repeat request, HARQ, acknowledgements and HARQ non-acknowledgements. In some embodiments, estimating the SINR distribution includes selecting a skewness of a probability distribution of the channel state measurements based at least in part on a reliability requirement. In some embodiments, estimating the SINR distribution includes selecting a skewness of a probability distribution of the channel state measurements based at least in part on at least one of received hybrid automatic repeat request, HARQ, acknowledgements and HARQ non-acknowledgements.

According to another aspect, a network node configured to communicate with a wireless device is provided. The network node includes a radio interface configured to receive an indicator of at least one channel state statistical value from the WD, a channel state statistical value being based at least in part on a plurality of channel state measurements. The network node also includes processing circuitry in communication with the radio interface and configured to: estimate a signal-to-interference-plus-noise ratio, SINR distribution based at least in part on the at least one channel state statistical value; and perform at least one action based at least in part on the estimated SINR distribution.

According to this aspect, in some embodiments, the at least one channel state statistical value includes a mean and one of a standard deviation and a variance. In some embodiments, the at least one channel state statistical value includes a skewness. In some embodiments, the at least one channel state statistical value is based at least in part on at least one of a channel quality indicator, CQI, and an efficiency. In some embodiments, the estimated SINR distribution is obtained from at least one of a table and a mapping function that provides an SINR value for a given value of the received indicator. In some embodiments, the processing circuitry is further configured to map the received indicator to a range of statistical values, and to select a value in the range of statistical values based at least in part on at least one of a latency requirement and a reliability requirement. In some embodiments, the processing circuitry is further configured to select a lowest value in the range of statistical values for ultra-reliable and low latency communications, URLLC. In some embodiments, estimating the SINR distribution includes adjusting an indicated channel state statistical value based on at least one of received hybrid automatic repeat request, HARQ, acknowledgements and HARQ non-acknowledgements. In some embodiments, estimating the SINR distribution includes selecting a skewness of a probability distribution of the channel state measurements based at least in part on a reliability requirement. In some embodiments, estimating the SINR distribution includes selecting a skewness of a probability distribution of the channel state measurements based at least in part on at least one of received hybrid automatic repeat request, HARQ, acknowledgements and HARQ non-acknowledgements.

According to another aspect, a method in a wireless device (WD) includes determining a plurality of measurements indicating a state of a channel of communication between the WD and the network node. The method also includes determining at least one channel state statistical value based at least in part on the plurality of measurements. The method also includes transmitting an indicator of the determined at least one channel statistical value.

According to this aspect, in some embodiments, the indicator corresponds to a range of channel statistical values. In some embodiments, the at least one channel state statistical value is an indicator of at least one of channel quality, signal-to-interference-plus-noise ratio, SINR, and efficiency. In some embodiments, the at least one channel state statistical value includes at least one of a mean, standard deviation, variance and skewness.

According to one aspect, a WD configured to communicate with a network node includes processing circuitry configured to: determine a plurality of measurements indicating a state of a channel of communication between the WD and the network node; and determine at least one channel state statistical value based at least in part on the plurality of measurements. The WD also includes a radio interface in communication with the processing circuitry and configured to transmit an indicator of the determined at least one channel statistical value.

According to this aspect, in some embodiments, the indicator corresponds to a range of channel statistical values. In some embodiments, the at least one channel state statistical value is an indicator of at least one of channel quality, signal-to-interference-plus-noise ratio, SINR, and efficiency. In some embodiments, the at least one channel state statistical value includes at least one of a mean, standard deviation, variance and skewness.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an exemplary network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating exemplary methods implemented in a communication system including a host computer, a network node and a wireless device for executing a client application at a wireless device according to some embodiments of the present disclosure;

FIG. 4 is a flowchart illustrating exemplary methods implemented in a communication system including a host computer, a network node and a wireless device for receiving user data at a wireless device according to some embodiments of the present disclosure;

FIG. 5 is a flowchart illustrating exemplary methods implemented in a communication system including a host computer, a network node and a wireless device for receiving user data from the wireless device at a host computer according to some embodiments of the present disclosure;

FIG. 6 is a flowchart illustrating exemplary methods implemented in a communication system including a host computer, a network node and a wireless device for receiving user data at a host computer according to some embodiments of the present disclosure;

FIG. 7 is a flowchart of an exemplary process in a network node according to some embodiments of the present disclosure;

FIG. 8 is a flowchart of an exemplary process in a wireless device according to some embodiments of the present disclosure;

FIG. 9 is a flowchart of another example process in a network node according to some embodiments disclosed herein; and

FIG. 10 is a flowchart of another example process in a wireless device according to some embodiments disclosed herein.

### DETAILED DESCRIPTION

Before describing in detail exemplary embodiments, it is noted that the embodiments reside primarily in combinations of apparatus components and processing steps related to using statistical CSI reports for evaluating a wireless communication channel. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Transmitting in downlink may pertain to transmission from the network or network node to the wireless device. Transmitting in uplink may pertain to transmission from the wireless device to the network or network node. Transmitting in sidelink may pertain to (direct) transmission from one wireless device to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

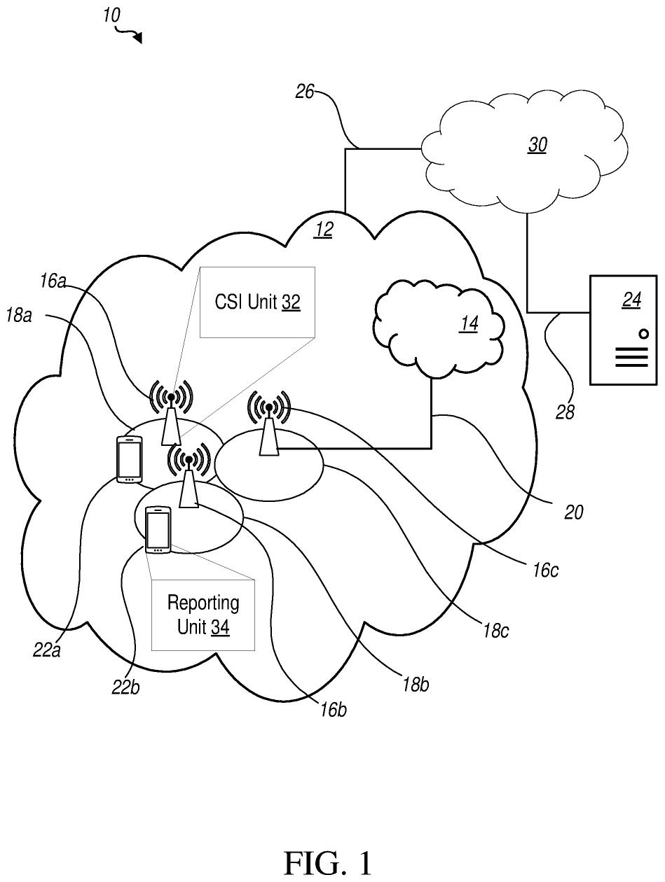

Some embodiments provide for statistical CSI reports for evaluating a wireless communication channel (e.g., for determining SINR associated with a wireless communication channel). Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a CSI unit 32 which is configured to perform one or more network node 16 functions described herein such as with respect to statistical CSI reports for evaluating a wireless communication channel. A wireless device 22 is configured to include a reporting unit 34 which is configured to perform one or more wireless device 22 functions as described herein such as with respect to statistical CSI reports for evaluating a wireless communication channel.

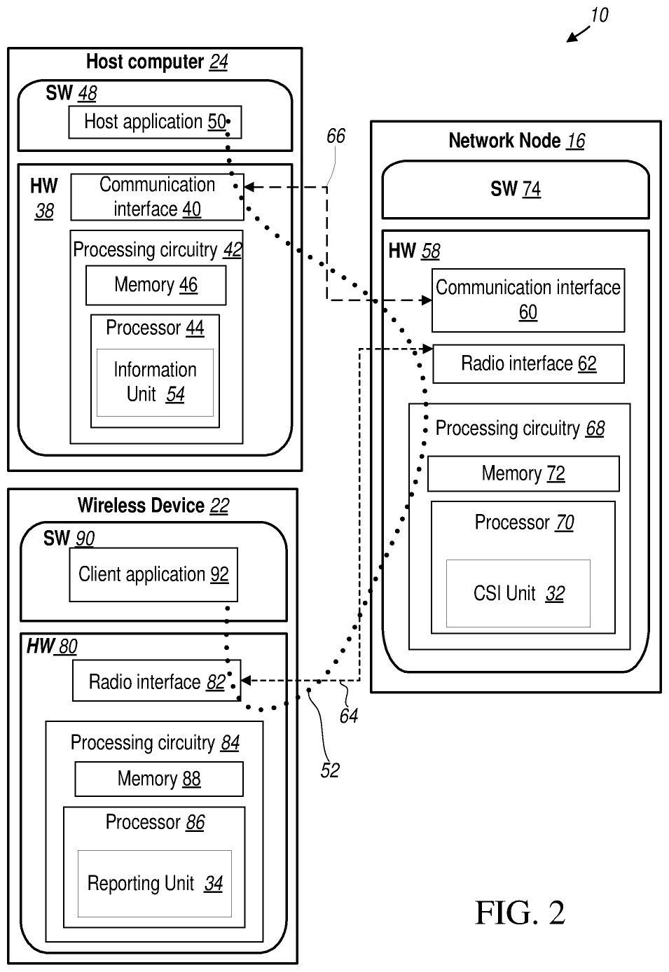

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to analyze, provide, store, transmit, receive, relay, forward, configure, etc., information related to statistical CSI reports for evaluating a wireless communication channel.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include CSI unit 32 configured to perform one or more network node 16 functions as described herein such as with respect to statistical CSI reports for evaluating a wireless communication channel.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a reporting unit 34 configured to perform one or more wireless device 22 functions as described herein such as with respect to statistical CSI reports for evaluating a wireless communication channel.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as CSI unit 32, and reporting unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

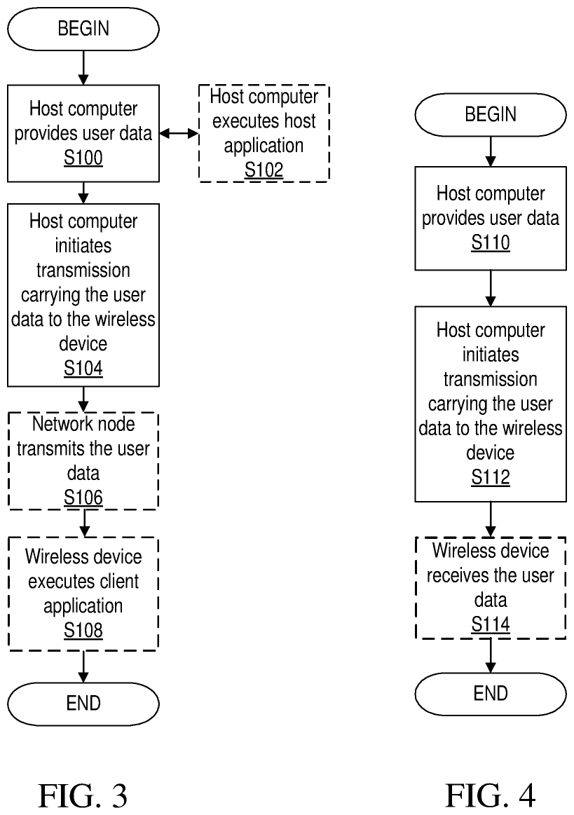

FIG. 3 is a flowchart illustrating an exemplary method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

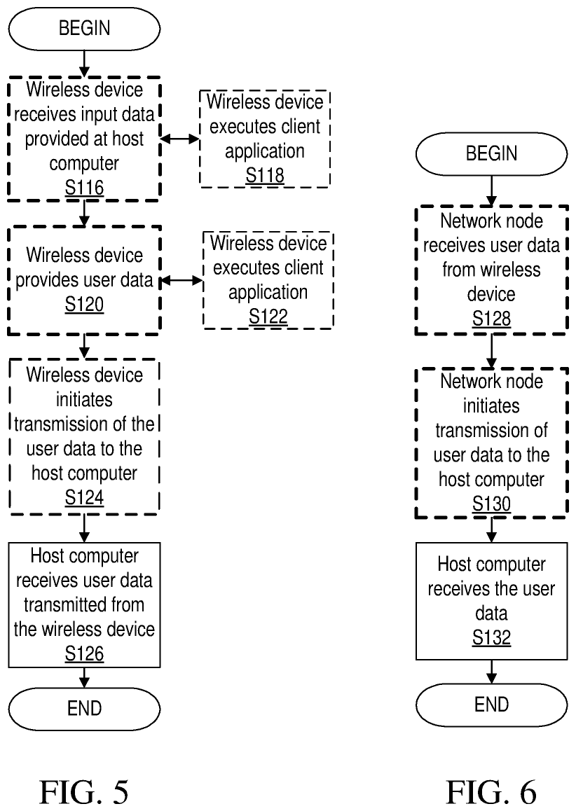

FIG. 5 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

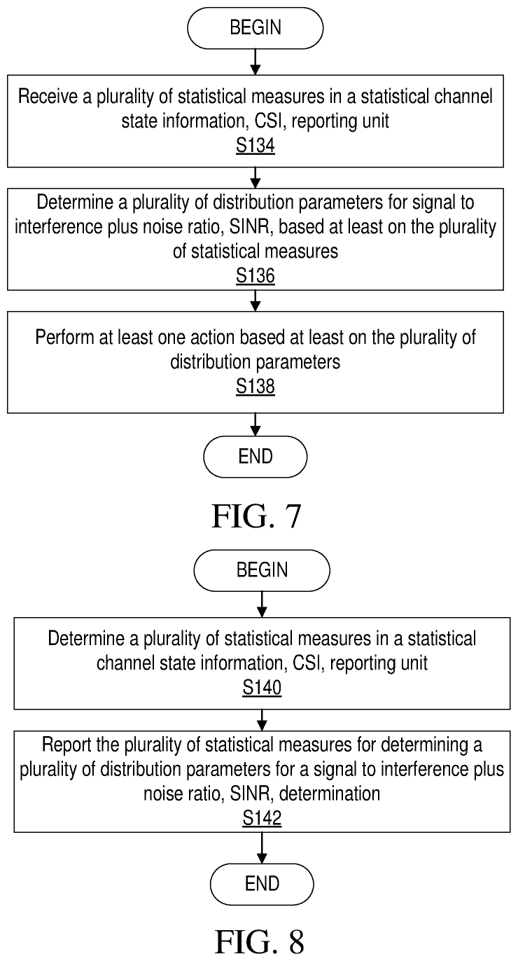

FIG. 7 is a flowchart of an exemplary process in a network node 16 according to some embodiments of the present disclosure. One or more blocks described herein may be performed by one or more elements of network node 16 such as by one or more of processing circuitry 68 (including the CSI unit 32), processor 70, radio interface 62 and/or communication interface 60. Network node 16 is configured to receive (Block S134) a plurality of statistical measures in a statistical channel state information, CSI, reporting unit, as described herein. Network node 16 is configured to determine (Block S136) a plurality of distribution parameters for signal to interference plus noise ratio, SINR, based at least on the plurality of statistical measures, as described herein. Network node 16 is configured to perform (Block S138) at least one action based at least on the plurality of distribution parameters, as described herein.

According to one or more embodiments, the plurality of statistical measures each correspond to a respective indicated range, and the processing circuitry is configured to select a value within each respective indicated range for determining the plurality of distribution parameters for the SINR, as described herein. According to one or more embodiments, the plurality of statistical measures each correspond to a respective indicated range, and the processing circuitry is configured to select a value within each respective indicated range and a skewness value for determining the plurality of distribution parameters for the SINR.

According to one or more embodiments, the CSI reporting unit is one of channel quality indicator, CQI, SINR and efficiency. According to one or more embodiments, the plurality of statistical measures include a mean and standard deviation of the statistical CSI reporting unit.

FIG. 8 is a flowchart of an exemplary process in a wireless device 22 according to some embodiments of the present disclosure. One or more blocks described herein may be performed by one or more elements of wireless device 22 such as by one or more of processing circuitry 84 (including the reporting unit 34), processor 86, radio interface 82 and/or communication interface 60. Wireless device 22 is configured to determine (Block S140) a plurality of statistical measures in a statistical channel state information, CSI, reporting unit, as described herein. Wireless device 22 is configured to report (Block S142) the plurality of statistical measures for determining a plurality of distribution parameters for a signal to interference plus noise ratio, SINR, determination, as described herein.

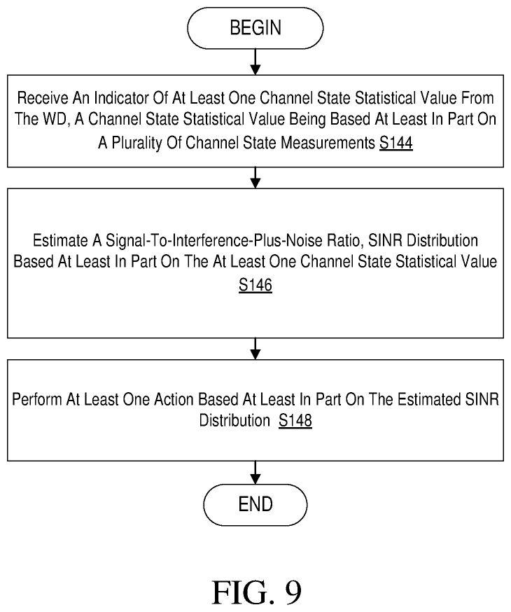

FIG. 9 is a flowchart of an example process in a network node 16 according to some embodiments of the present disclosure. One or more blocks described herein may be performed by one or more elements of network node 16 such as by one or more of processing circuitry 68 (including the CSI unit 32), processor 70, radio interface 62 and/or communication interface 60. Network node 16 is configured to receive an indicator of at least one channel state statistical value from the WD, a channel state statistical value being determined based at least in part on a plurality of channel state measurements (Block S144). The process also includes estimating a signal-to-interference-plus-noise ratio, SINR distribution based at least in part on the at least one channel state statistical value (Block S146). The process further includes performing at least one action based at least in part on the estimated SINR distribution (Block S148).

In some embodiments, the at least one channel state statistical value includes a mean and one of a standard deviation and a variance. In some embodiments, the at least one channel state statistical value includes a skewness. In some embodiments, the at least one channel state statistical value is based at least in part on at least one of a channel quality indicator, CQI, and an efficiency. In some embodiments, the estimated SINR distribution is obtained from at least one of a table and a mapping function that provides an SINR value for a given value of the received indicator. In some embodiments, the received indicator is mapped to a range of statistical values, and the method further includes selecting a value in the range of statistical values based at least in part on at least one of a latency requirement and a reliability requirement. In some embodiments, the process includes selecting a lowest value in the range of statistical values for ultra-reliable and low latency communications, URLLC. In some embodiments, estimating the SINR distribution includes adjusting an indicated channel state statistical value based on at least one of received hybrid automatic repeat request, HARQ, acknowledgements and HARQ non-acknowledgements. In some embodiments, estimating the SINR distribution includes selecting a skewness of a probability distribution of the channel state measurements based at least in part on a reliability requirement. In some embodiments, estimating the SINR distribution includes selecting a skewness of a probability distribution of the channel state measurements based at least in part on at least one of received hybrid automatic repeat request, HARQ, acknowledgements and HARQ non-acknowledgements.

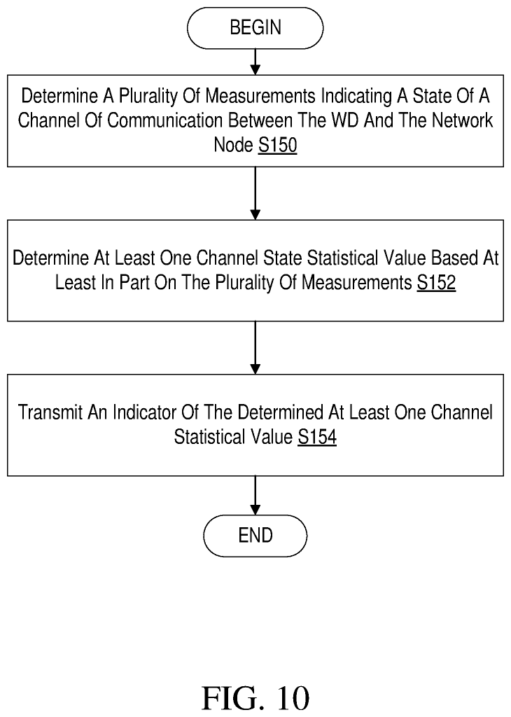

FIG. 10 is a flowchart of an example process in a wireless device 22 according to some embodiments of the present disclosure. One or more blocks described herein may be performed by one or more elements of wireless device 22 such as by one or more of processing circuitry 84 (including the reporting unit 34), processor 86, radio interface 82 and/or communication interface 60. Wireless device 22 is configured to determine a plurality of measurements indicating a state of a channel of communication between the WD and the network node (Block S150). The process includes determining at least one channel state statistical value based at least in part on the plurality of measurements (Block S152). The process also includes transmitting an indicator of the determined at least one channel statistical value (Block S154).

In some embodiments, the indicator corresponds to a range of channel statistical values. In some embodiments, the at least one channel state statistical value is an indicator of at least one of channel quality, signal-to-interference-plus-noise ratio, SINR, and efficiency. In some embodiments, the at least one channel state statistical value includes at least one of a mean, standard deviation, variance and skewness.

According to one or more embodiments, the plurality of statistical measures each corresponds to a respective indicated range, as described herein. According to one or more embodiments, the CSI reporting unit is one of channel quality indicator, CQI, SINR and efficiency, as described herein. According to one or more embodiments, the plurality of statistical measures include a mean and standard deviation of the statistical CSI reporting unit, as described herein.

Having generally described arrangements for statistical CSI reports for evaluating a wireless communication channel, details for these arrangements, functions and processes are provided as follows, and which may be implemented by the network node 16, wireless device 22 and/or host computer 24.

Some embodiments provide for statistical CSI reports for evaluating a wireless communication channel.

### Examples: Estimating Standard Deviation of SINR

Wireless device 22 is assumed to report indicators for mean CQI, m_{CQI}, and CQI standard deviation s_{CQI}, (or variance CQI). The indicator for mean CQI may coincide with a legacy CQI table where the wireless device 22 would report a value/(m_{CQI})=3 if 3≤m_{CQI}<4. Such indicators can be determined, for example, by processing circuitry 84 in conjunction with radio interface 82. The indicator for s_{CQI} is assumed to be defined by a mapping table, e.g., 3-bit indicator defined by Table 5 below.

TABLE 5

| s_{CQI} | |
|---|---|
| indicator | s_{CQI} |
| 0 | s_{CQI} < 0.1 |
| 1 | 0.1 ≤ s_{CQI} < 0.25 |
| 2 | 0.25 ≤ s_{CQI} < 0.5 |
| 3 | 0.5 ≤ s_{CQI} < 1.0 |
| 4 | 1.0 ≤ s_{CQI} < 1.6 |
| 5 | 1.6 ≤ s_{CQI} < 2.3 |
| 6 | 2.3 ≤ s_{CQI} < 3.0 |
| 7 | 3.0 ≤ s_{CQI} |

For both mean and standard deviation, the indicator indicates a range of values. Let g(.) denote a function selecting a value in a range indicated by input argument. For example, if input argument is the s_{CQI} indicator I(s_{CQI}) then if/(s_{CQI})=2 then g(I(s_{CQI}))=0.3 or some other value inside the range [0.25, 0.5]. Note that g (I(s_{CQI}))=0.5 is allowed even though the range for the indicator does not include 0.5.

An estimate for m_{SINR} can be determined by selecting a value in the range indicated by the indicator/(m_{CQI}) for m_{CQI}. For example, if I(m_{CQI})=3 with the 256 QAM CQI table it is known that mean CQI is in range [3,4] which from Table 4 indicates a mean SINR in range [0.3, 4.2] dB where the middle value of 0.5 is selected as the estimate. If the estimated mean SINR is intended to be used in link adaption (i.e., an example of at least one action) for URLLC with extreme latency and reliability requirement, the selected value may instead be the lowest value in the range, i.e., 0.3 of the range [0.3, 4.2] dB. If the latency and reliability requirement are less extreme, a value closer to the middle value may be selected.

For the estimate ŝ_{SINR} for ŝ_{SINR}, it is determined based on at least the indicator I(s_{CQI}) and the required SINR values for CQI. In one example, ŝ_{SINR}=kg(I(s_{CQI})), where k is a scaling factor from CQI to SINR domain. In one such example, k is a rough approximation of a SINR step in required SINR for a unit step in CQI. From Table 4 it is illustrated that k=2.0 is one example of such rough approximation.

In another more accurate example, ŝ_{SINR}=f(I(m_{CQI})) g(I(s_{CQI})), where f(I(m_{CQI})) is function depending on/(m_{CQI}) (i.e., the indicator for m_{CQI}). For example, f(I(m_{CQI})) may be the SINR step corresponding a CQI step in the neighborhood of/(m_{CQI}). In such an example where I(m_{CQI}) is reported by wireless device 22 using the 256 QAM CQI table and I(m_{CQI})=2 then f (I(m_{CQI}))=0.5(0.3−(−7.7)), i.e., a mean SINR step for a CQI step in the CQI range 1-3. The values for function ƒ (.) could be the entries in a table such as Table 6 illustrated below.

TABLE 6

| I(m_{CQI}) | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| f (I(m_{CQI})) | 2.7 | 2.7 | 4.0 | 4.4 | 2.9 | 1.9 | 2.1 | 2.0 | 1.8 | 1.8 | 1.8 | 2.0 | 1.8 | 1.7 | 1.7 | 1.5 |

In some embodiments, the function ƒ (.) and/or g(.) depends on latency and/or the reliability requirement. For example, g(.) may determine the minimum (or maximum) value if latency and/or reliability requirement is above (or below) a threshold. There may be one or more thresholds that g(.) depends on if the latency and/or reliability requirement is above a first threshold but below a second threshold. For example, if xₘᵢₙ and xₘₐₓ is the minimum and maximum value respectively in the range then g(.) may be defined as

$$g ( . ) = \{ \begin{matrix}{x}_{max} , reliablity > 99.99 \% \\ 0.7 {x}_{max} , 9 9.9 \% \leq reliablity < 99.99 \% \\ 0.5 ( {x}_{min} + {x}_{max} ) , otherwise\end{matrix}$$

In the above example, a larger value increases reliability, i.e., will result in a more conservative assumption on the distribution of SINR. In other examples, a lower value increases the reliability and hence it may be preferable to replace “max” by “min”.

In other examples, ŝ_{SINR}=h(I(m_{CQI}), I(s_{CQI})), where h(.) is defined by a table. In some such examples, the entries are determined as the maximum standard deviation for a normally distributed random variable for SINR with a mean corresponding to g (I(m_{CQI})) (i.e., the value selected, e.g., a minimum value, in the range indicated by I (m_{CQI})) that for a large number of realizations of SINR would result in a reported I(s_{CQI}). One example of such is illustrated in Table 7 below:

TABLE 7
Table of estimated standard deviation SINR (ŝ_{SINR})

| | I(s_{CQI}) | | | | | | | |
|---|---|---|---|---|---|---|---|---|
| I(m_{CQI}) | 0 | 1 | 2 | 3 | 4 | 5 | 6 | 7 |
| 0 | 0.28 | 0.48 | 0.75 | 2.1 | 5.6 | 8.5 | 11.0 | 13.8 |
| 1 | 0.38 | 0.61 | 0.84 | 1.4 | 4.3 | 7.3 | 9.8 | 12.2 |
| 2 | 0.57 | 0.93 | 1.3 | 2.0 | 3.8 | 5.8 | 8.0 | 10.2 |
| 3 | 0.45 | 0.74 | 1.0 | 1.6 | 2.9 | 4.6 | 6.4 | 8.3 |
| 4 | 0.22 | 0.34 | 0.48 | 0.78 | 2.1 | 3.8 | 5.6 | 7.4 |
| 5 | 0.22 | 0.38 | 0.53 | 0.86 | 1.9 | 3.4 | 5.1 | 6.8 |
| 6 | 0.26 | 0.44 | 0.60 | 0.96 | 1.9 | 3.1 | 4.6 | 6.3 |
| 7 | 0.21 | 0.32 | 0.44 | 0.73 | 1.8 | 3.0 | 4.4 | 6.0 |
| 8 | 0.23 | 0.36 | 0.50 | 0.82 | 1.7 | 2.9 | 4.3 | 5.8 |
| 9 | 0.19 | 0.34 | 0.46 | 0.74 | 1.7 | 2.9 | 4.2 | 5.7 |
| 10 | 0.23 | 0.35 | 0.49 | 0.80 | 1.8 | 2.9 | 4.2 | 5.8 |
| 11 | 0.26 | 0.41 | 0.58 | 0.91 | 1.8 | 2.9 | 4.3 | 6.0 |
| 12 | 0.16 | 0.27 | 0.37 | 0.61 | 1.7 | 2.9 | 4.6 | 6.6 |
| 13 | 0.23 | 0.38 | 0.52 | 0.84 | 1.6 | 3.1 | 5.1 | 7.3 |
| 14 | 0.18 | 0.28 | 0.39 | 0.64 | 1.9 | 3.7 | 5.9 | 8.2 |
| 15 | 0.26 | 0.43 | 0.66 | 1.32 | 2.8 | 4.7 | 6.9 | 9.2 |

In other examples, table entries could be minimum standard deviation for the random variable or a value between minimum and maximum standard deviation for a normally distributed random variable for SINR with a mean corresponding to g (I(m_{CQI}) that for a large number of realizations of SINR would result in a reported I(s_{CQI}).

In another example, wireless device 22 can report an interference statistic (such as interference to noise ratio, INR) in dB units or as a function of time/probability distribution function (PDF)/cumulative distribution function (CDF). In this case, the network node 16 may need to combine knowledge about the latest or more recent CQI value or CQI averaged over time with an interference distribution to calculate an SINR distribution. One assumption that may be made in some embodiments is that mean CQI or mean SINR corresponds to mean INR.

In some embodiments, the estimated mean and/or standard deviation is adjusted based on received HARQ-ACK. In some examples, the estimated mean is adjusted by a backoff that is negatively adjusted when HARQ-ACK indicates ACK while positively adjusted when HARQ-ACK indicates NACK. In some examples, the standard deviation is adjusted by a backoff that is negatively adjusted when HARQ-ACK indicates NACK while positively adjusted when HARQ-ACK indicates ACK. The adjustment step may depend on latency and reliability requirements.

### Examples: Estimating Parameters Assuming Skewed-Normal Distribution

For a random variable X with mean m, the skewness γ₁ is defined as

$${γ}_{1} = \frac{E \{ {( X - m )}^{3} \}}{E {\{ {( X - m )}^{2} \}}^{3 / 2}} .$$

If γ₁<0 then X is negatively skewed which means that the PDF (Probability Distribution Function) has a longer left-tail than right-tail. The class of skew-normal distributions is a class of distributions that can be fully described by three parameters where the skewness is in the range [−1, 1]. Normal distributions are included in the class of skew-normal distributions, i.e., those skew-normal distributions with γ₁=0. Since the true distribution of SINR is often negatively skewed it may be un-suitable to assume that SINR is normally distributed. A more accurate assumption may be to assume that SINR is skew-normally distributed. The distribution parameters for a skew-normal random variable can be determined from the mean, standard deviation and the skewness γ₁.

If wireless device 22 reports indicators for mean CQI and standard deviation CQI then the mean and standard deviation of SINR can be estimated using the methods in the previous section (i.e., Embodiment: Estimating standard deviation of SINR section) while any potential skewness in SINR distribution may need to be estimated/selected using other methods.

In some embodiments, a skewness less than one is selected if the SINR distribution is used for URLLC where the latency and/or reliability requirement is above a threshold. For example, if the reliability requirement is above T, e.g., corresponding to a reliability of 99.9%, then a skewness is selected to be a negative value, otherwise γ₁=0 is assumed/selected. In other examples, there are multiple thresholds for the latency and/or reliability and the skewness is assumed/selected based on whether the latency and/or reliability is above a first threshold and below a second threshold.

In some embodiments, the assumed/selected skewness is adjusted based on received HARQ-ACK. In some examples, the assumed/selected skewness is negatively adjusted when HARQ-ACK indicates NACK while it is positively adjusted when HARQ-ACK indicates ACK. In other examples, if adjusted skewness reaches −1 or 1 no further skewness adjustments are made while adjustment could instead be applied on estimated mean or standard deviation of SINR. For example, if HARQ-ACK indicates NACK and assumed/selected skewness is already −1 then the estimated mean of SINR may be negatively adjusted and/or the estimated standard deviation of SINR may be positively adjusted.

In some embodiments, the initial assumed/selected skewness is dependent on a latency and/or reliability requirement. For example, if the estimated/selected SINR distribution parameters are used in link adaption (e.g., at least one action) for URLLC, the initial value may be a value less than 0 and 0 otherwise. The initial value for the skewness may be assumed/selected based on one or more thresholds with respect to latency and/or reliability requirement. While one or more embodiments described herein relate to using the SINR distribution parameters for link adaption, the teachings described herein are equally applicable to other network node 16 and/or network actions.

### Methods for Above Embodiments

Since instantaneous SINR statistics can differ for one MIMO layer or multiple MIMO layers, estimation of SINR distribution parameters may further be based on rank and/or per transport block. For example, if rank is above a threshold, first functions for f (.) and/or g(.) in the “Examples: Estimating parameters assuming skewed-normal distribution” section are used, otherwise second functions for f(.) and/or g(.) are used. If statistical CSI is reported per two or more transport blocks the methods described herein may be performed per transport block.

### Assumed/Used Distributions

In embodiments above, a normal distribution is assumed. The normal distribution assumption is an example and should not be interpreted as limiting. Similar embodiments exist wherein a different distribution is assumed. Any distribution that can be fully or at least partially described by mean and standard deviation could be used instead.

Thus, in some embodiments, a skew-normal distribution is assumed. A distribution that can be fully described by the mean, standard deviation and skewness can be used instead.

### Efficiency or Symbol Information as Statistical CSI Unit

In some embodiments described above, the statistical CSI unit is CQI. The statistical CSI unit may be an efficiency or other measure. For example, assume the mean for statistical CSI could be reported using a legacy CQI table, e.g., Table 4, while standard deviation would be reported using an indicator indicating a range, e.g., [eff₁, eff₂], of efficiency standard deviation values. The function g(.) may be a function mapping to an efficiency standard deviation in the range, e.g., to an efficiency eff such that eff₁≤eff≤eff₂. The function could depend on latency and/or reliability requirements. Further, in a neighborhood of SINR, a factor for how much SINR varies per efficiency unit may be used. At a neighborhood of SINR=5 dB (e.g., between CQI 4 and 5), the factor is roughly

$$\frac{6.0 - 4.2}{1.9141 - 1.4766} \approx 4.1 .$$

Thus, in a neighborhood of SINR=5 dB, the function ƒ (.) could be chosen to have the value 4.1.

### Reported Statistical Measures

In one or more embodiments, the std (standard deviation) is given as an example of a variation measure. Other variation measures are variance and percentiles. Variants of the above embodiments is possible where the variation measure is other than standard deviation. For example, variance is a measure equivalent to standard deviation since variance is the square of standard deviation and for many distributions their parameters can be determined from mean and standard deviation, mean and a percentile or two percentile values. Thus, although the reporting measures are different the information content is the same.

Furthermore, the reported measures are sample measures meaning that they are determined from a number of realizations. This means that a reporting value such as minimum and maximum is actually a report of a percentile value. For example, the minimum value of 30 realizations is an estimate of the value x for which the probability that a realization is less than 1/30, i.e., the minimum value can be used as an estimate of 1/30 percentile.

Therefore, one or more embodiments of the present disclosure advantageously provide for determining precise estimates of SINR distribution parameters that enables the link adapter and scheduler in a network node to maximize spectral efficiency while ensuring that latency and reliability requirements can be met. Further, the estimate of SINR distribution parameters may be based on statistical measures in a statistical CSI reporting unit that is determined and reported by the wireless devices as described herein.

Some embodiments may include one or more of the following.

Embodiment A1. A network node configured to communicate with a wireless device (WD), the network node configured to, and/or comprising a radio interface and/or comprising processing circuitry configured to:
receive a plurality of statistical measures in a statistical channel state information, CSI, reporting unit;
determine a plurality of distribution parameters for signal to interference plus noise ratio, SINR, based at least on the plurality of statistical measures; and
perform at least one action based at least on the plurality of distribution parameters.

Embodiment A2. The network node of Embodiment A1, wherein the plurality of statistical measures each correspond to a respective indicated range; and
the processing circuitry is configured to select a value within each respective indicated range for determining the plurality of distribution parameters for the SINR.

Embodiment A3. The network node of Embodiment A1, wherein the plurality of statistical measures each correspond to a respective indicated range; and
the processing circuitry is configured to select a value within each respective indicated range and a skewness value for determining the plurality of distribution parameters for the SINR.

Embodiment A4. The network node of any one of Embodiments A1-A3, wherein the CSI reporting unit is one of channel quality indicator, CQI, SINR and efficiency.

Embodiment A5. The network node of any one of Embodiments A1-A4, wherein the plurality of statistical measures include a mean and standard deviation of the statistical CSI reporting unit.

Embodiment B1. A method implemented in a network node, the method comprising:
receiving a plurality of statistical measures in a statistical channel state information, CSI, reporting unit;
determining a plurality of distribution parameters for signal to interference plus noise ratio, SINR, based at least on the plurality of statistical measures; and
performing at least one action based at least on the plurality of distribution parameters.

Embodiment B2. The method of Embodiment B1, wherein the plurality of statistical measures each correspond to a respective indicated range; and
the processing circuitry is configured to select a value within each respective indicated range for determining the plurality of distribution parameters for the SINR.

Embodiment B3. The method of Embodiment B1, wherein the plurality of statistical measures each correspond to a respective indicated range; and
the processing circuitry is configured to select a value within each respective indicated range and a skewness value for determining the plurality of distribution parameters for the SINR.

Embodiment B4. The method of any one of Embodiments B1-B3, wherein the CSI reporting unit is one of channel quality indicator, CQI, SINR and efficiency.

Embodiment B5. The method of any one of Embodiments B1-B4, wherein the plurality of statistical measures include a mean and standard deviation of the statistical CSI reporting unit.

Embodiment C1. A wireless device (WD) configured to communicate with a network node, the WD configured to, and/or comprising a radio interface and/or processing circuitry configured to:
determine a plurality of statistical measures in a statistical channel state information, CSI, reporting unit; and
report the plurality of statistical measures for determining a plurality of distribution parameters for a signal to interference plus noise ratio, SINR, determination.

Embodiment C2. The WD of Embodiment C1, wherein the plurality of statistical measures each correspond to a respective indicated range.

Embodiment C3. The WD of any one of Embodiments C1-C2, wherein the CSI reporting unit is one of channel quality indicator, CQI, SINR and efficiency.

Embodiment C4. The WD of any one of Embodiments C1-C3, wherein the plurality of statistical measures include a mean and standard deviation of the statistical CSI reporting unit.

Embodiment D1. A method implemented in a wireless device (WD), the method comprising:
determining a plurality of statistical measures in a statistical channel state information, CSI, reporting unit; and
reporting the plurality of statistical measures for determining a plurality of distribution parameters for a signal to interference plus noise ratio, SINR, determination.

Embodiment D2. The method of Embodiment D1, wherein the plurality of statistical measures each correspond to a respective indicated range.

Embodiment D3. The method of any one of Embodiments D1-D2, wherein the CSI reporting unit is one of channel quality indicator, CQI, SINR and efficiency.

Embodiment D4. The method of any one of Embodiments D1-D3, wherein the plurality of statistical measures include a mean and standard deviation of the statistical CSI reporting unit.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD, the network node comprising:
a radio interface configured to receive an indicator of at least one channel state statistical value from the WD, a channel state statistical value being based at least in part on a plurality of channel state measurements; and
processing circuitry in communication with the radio interface and configured to:
estimate a signal-to-interference-plus-noise ratio, SINR distribution based at least in part on the at least one channel state statistical value; and
perform at least one action based at least in part on the estimated SINR distribution.

2. The network node of claim 1, wherein the at least one channel state statistical value includes a mean and one of a standard deviation and a variance.

3. The network node of claim 1, wherein the at least one channel state statistical value includes a skewness.

4. The network node of claim 1, wherein the at least one channel state statistical value is based at least in part on at least one of a channel quality indicator, CQI, and an efficiency.

5. The network node of claim 1, wherein the estimated SINR distribution is obtained from at least one of a table and a mapping function that provides an SINR value for a given value of the received indicator.

6-10. (canceled)

11. A method in a network node configured to communicate with a wireless device, WD, the method comprising:
receiving an indicator of at least one channel state statistical value from the WD, a channel state statistical value being determined based at least in part on a plurality of channel state measurements;
estimating a signal-to-interference-plus-noise ratio, SINR distribution based at least in part on the at least one channel state statistical value; and
performing at least one action based at least in part on the estimated SINR distribution.

12. The method of claim 11, wherein the at least one channel state statistical value includes a mean and one of a standard deviation and a variance.

13. The method of claim 11, wherein the at least one channel state statistical value includes a skewness.

14. The method of claim 11, wherein the at least one channel state statistical value is based at least in part on at least one of a channel quality indicator, CQI, and an efficiency.

15. The method of claim 11, wherein the estimated SINR distribution is obtained from at least one of a table and a mapping function that provides an SINR value for a given value of the received indicator.

16. The method of claim 15, wherein the received indicator is mapped to a range of statistical values, and the method further includes selecting a value in the range of statistical values based at least in part on at least one of a latency requirement and a reliability requirement.

17. The method of claim 16, further comprising selecting a lowest value in the range of statistical values for ultra-reliable and low latency communications, URLLC.

18. The method of claim 11, wherein estimating the SINR distribution includes adjusting an indicated channel state statistical value based on at least one of received hybrid automatic repeat request, HARQ, acknowledgements and HARQ non-acknowledgements.

19. The method of claim 11, wherein estimating the SINR distribution includes selecting a skewness of a probability distribution of the channel state measurements based at least in part on a reliability requirement.

20. The method of claim 11, wherein estimating the SINR distribution includes selecting a skewness of a probability distribution of the channel state measurements based at least in part on at least one of received hybrid automatic repeat request, HARQ, acknowledgements and HARQ non-acknowledgements.

21. A wireless device, WD, configured to communicate with a network node, the WD comprising:
processing circuitry configured to:
determine a plurality of measurements indicating a state of a channel of communication between the WD and the network node; and
determine at least one channel state statistical value based at least in part on the plurality of measurements; and
a radio interface in communication with the processing circuitry and configured to transmit an indicator of the determined at least one channel statistical value.

22-24. (canceled)

25. A method in a wireless device, WD, configured to communicate with a network node, the method comprising:
determining a plurality of measurements indicating a state of a channel of communication between the WD and the network node; and
determining at least one channel state statistical value based at least in part on the plurality of measurements; and
transmitting an indicator of the determined at least one channel statistical value.

26. The method of claim 25, wherein the indicator corresponds to a range of channel statistical values.

27. The method of claim 25, wherein the at least one channel state statistical value is an indicator of at least one of channel quality, signal-to-interference-plus-noise ratio, SINR, and efficiency.

28. The method of claim 25, wherein the at least one channel state statistical value includes at least one of a mean, standard deviation, variance and skewness.
